(19) United States
(12) Patent Application Publication
(10) Pub. No.: US 2023/0028354 A1
(43) Pub. Date: Jan. 26, 2023

(54) DEVICE MAINTENANCE SUPPORT SYSTEM

(71) Applicant: DAIKIN INDUSTRIES, LTD., Osaka (JP)

(72) Inventor: Satoshi YOSHIKAWA, Osaka (JP)

(21) Appl. No.: 17/959,820

(22) Filed: Oct. 4, 2022

Related U.S. Application Data
(63) Continuation of application No. PCT/JP2021/014183, filed on Apr. 1, 2021.

(30) Foreign Application Priority Data
Apr. 8, 2020 (JP) 2020-069591

(51) Int. Cl. G06Q 10/00; G06Q 30/02

(52) U.S. Cl. CPC G06Q 10/20; G06Q 30/0283

(57) ABSTRACT

A device maintenance support system proposes, among a plurality of devices installed, a maintenance target device and a maintenance timing. The device maintenance support system includes an information acquisition unit and a running cost prediction unit. The information acquisition unit acquires, from the devices, device identification information and device information including parameters that change according to performance deterioration of components of the devices. The running cost prediction unit predicts an increase in a running cost due to the performance deterioration of components of the devices. Among combinations of the devices on which maintenance may be performed and the maintenance timing, the maintenance target device and the maintenance timing thereof for which a total cost is lowest are proposed. The total cost is a sum of the increase in the running cost of all the devices and the maintenance cost incurred for the maintenance target device.

### CROSS-REFERENCE TO RELATED APPLICATIONS

This is a continuation of International Application No. PCT/JP2021/014183 filed on Apr. 1, 2021, which claims priority to Japanese Patent Application No. 2020-069591, filed on Apr. 8, 2020. The entire disclosures of these applications are incorporated by reference herein.

### BACKGROUND

### Technical Field

The present disclosure relates to a device maintenance support system.

### Background Art

Devices including air conditioners require maintenance depending on a use state of components. Conventionally, a maintenance worker regularly visits a user for maintenance. Alternatively, as disclosed in Japanese Unexamined Patent Application Publication No. 2002-215759, the maintenance worker visits the user in response to a notification from a device including an air conditioner.

### SUMMARY

A device maintenance support system according to a first aspect proposes, among a plurality of devices installed, a maintenance target device and a maintenance timing. The device maintenance support system according to the first aspect includes an information acquisition unit, and a running cost prediction unit. The information acquisition unit is configured to acquire, from the devices, device identification information and device information including parameters that change according to performance deterioration of components of the devices. The running cost prediction unit is configured to predict an increase in a running cost due to the performance deterioration of components of the devices. Among combinations of the devices on which maintenance may be performed and the maintenance timing in a case of performing maintenance, the maintenance target device and the maintenance timing thereof for which a total cost is lowest are proposed. The total cost is a sum of the increase in the running cost of all the devices and the maintenance cost incurred for the maintenance target device.

### BRIEF DESCRIPTION OF THE DRAWINGS

FIG. 1 is a schematic diagram illustrating a configuration of a device maintenance support system.

FIG. 2 is a schematic diagram illustrating a configuration of an air conditioner.

FIG. 3 is a schematic diagram illustrating functional blocks of devices constituting the device maintenance support system.

FIG. 4 is a flowchart for describing an operation of the device maintenance support system.

### DETAILED DESCRIPTION OF EMBODIMENT(S)

Hereinafter, a device maintenance support system 1 according to the present disclosure will be described with reference to the drawings as appropriate. Note that the following embodiment is a specific example and does not limit the technical scope, and can be changed as appropriate without departing from the spirit.

(1) Overall Configuration

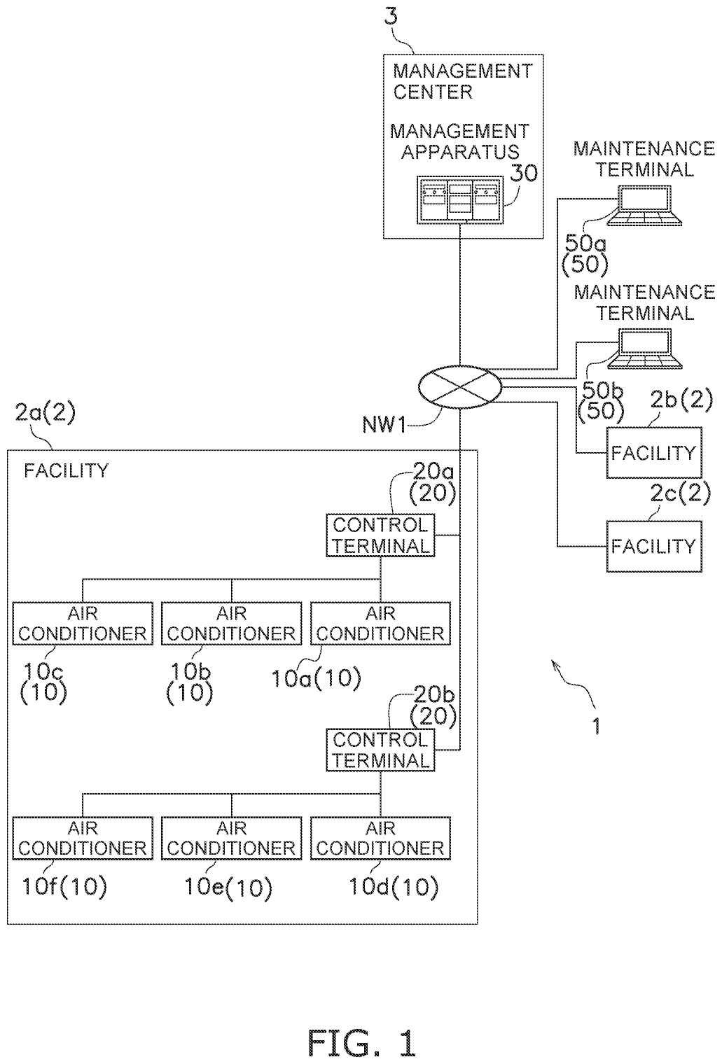

FIG. 1 is a schematic diagram illustrating a configuration of the device maintenance support system 1 according to an embodiment of the present disclosure. In the following description, a description that is common to a plurality of apparatuses having substantially the same functions will be denoted by the same reference signs. When one apparatus is distinguished from a plurality of apparatuses having substantially the same functions, the apparatus is described with a suffix of a lower-case letter attached thereto. For example, control terminals 20a and 20b are apparatuses having substantially the same functions and thus will be referred to as a control terminal 20 or control terminals 20 in a case where descriptions are common. Although suffixes such as a to c are used for convenience of description, they represent given numbers, and the number is not limited thereto.

The device maintenance support system 1 is a system in which a management apparatus 30, which is a single apparatus, supports maintenance of a large number of devices. Here, the management apparatus 30 is installed in a management center 3. A large number of facilities 2a to 2c exist in the jurisdiction area of the management center 3. The facilities 2a to 2c are, for example, an office building, a commercial building, and a condominium. One or a plurality of air conditioners 10a to 10f are installed in each of the facilities 2a to 2c as examples of the devices to be managed. Either of the plurality of control terminals 20a and 20b is connected to each of the air conditioners 10a to 10f. In the device maintenance support system 1, the plurality of air conditioners 10a to 10f are managed by the control terminals 20a and 20b and the management apparatus 30 communicating device information and device identification information, which will be described later.

The management apparatus 30 is connected to the plurality of control terminals 20a and 20b and a plurality of maintenance terminals 50a and 50b via a communication network NW1.

The communication network NW1 includes a wide area network (WAN) across a plurality of properties. For example, the communication network NW1 includes the Internet.

Note that the numbers of control terminals 20 and maintenance terminals 50 can be appropriately changed. In addition, the number of facilities 2 and/or the number of management centers 3 can also be appropriately changed.

(2) Maintenance Target Device

The device maintenance support system 1 according to the present embodiment is a system that supports maintenance of the devices. An example of a maintenance target device of the device maintenance support system 1 is an air conditioner that performs cooling or heating of a target space. Hereinafter, a configuration of an air conditioner 10 as an example of the device for which the device maintenance support system 1 performs maintenance support will be described. In the present disclosure, the device is not limited to an air conditioner. For example, a ventilator, a total heat exchanger, an air cleaner, and/or other refrigeration apparatuses may be adopted as the device. The device installed in a facility 2 is not limited to the air conditioner 10. For example, various refrigeration apparatuses such as an air conditioner, a ventilator, a total heat exchanger, and an air cleaner may be installed in the facility 2.

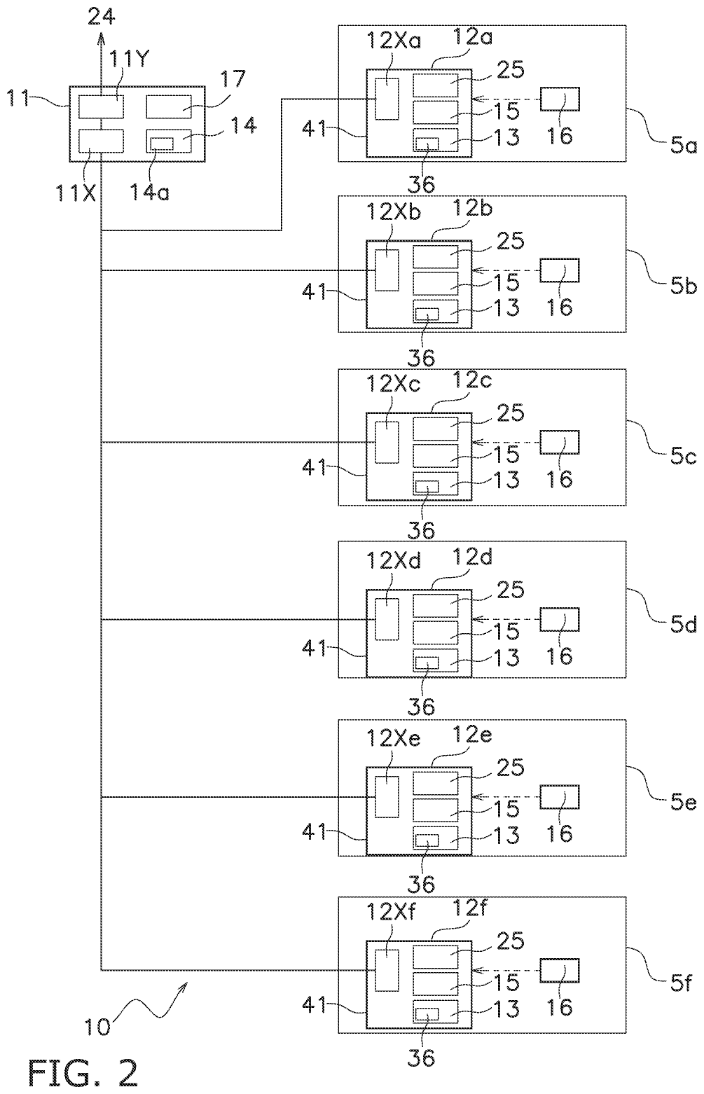

FIG. 2 is a schematic diagram illustrating a configuration of the air conditioner 10 according to the present embodiment. Although omitted from the illustration, the air conditioner 10 has a refrigerant circuit including a compressor 14 and the like. The air conditioner 10 includes an outdoor unit 11 and a plurality of indoor units 12a to 12f. The outdoor unit 11 and indoor units 12 are connected via dedicated communication lines. The outdoor unit 11 is provided with an outdoor unit control circuit 11X. Each of the indoor units 12a to 12f is provided with a corresponding one of indoor unit control circuits 12Xa to 12Xf. Various sensors are appropriately attached to predetermined positions of the outdoor unit 11 and each indoor unit 12. These sensors detect various types of data relating to the air conditioner 10. Various types of data include, for example, but not limited to, the room temperature of an air-conditioning target space 5 in which the indoor unit 12 is installed, the ambient temperature of the position at which the outdoor unit 11 is installed, the temperature and the pressure of refrigerant sucked into the compressor 14, the temperature and the pressure of refrigerant discharged from the compressor 14, the number of revolutions of a compressor motor 14a of the compressor 14, the temperature of refrigerant in an evaporator, the temperature of refrigerant in a condenser, the number of revolutions of a fan motor 36 of an indoor fan 13, the temperature of a heat exchanger 25, and the like. On the basis of various types of data detected by various sensors, the outdoor unit control circuit 11X and an indoor unit control circuit 12X cooperate with each other to control the operation of each part of the air conditioner 10. The air conditioner 10 is operated on the basis of control information input from an operation terminal 16 such as a remote controller and/or an operation panel.

(2-1) Outdoor Unit 11

The outdoor unit 11 is installed, for example, on a rooftop or in a basement, and functions as a heat source of the refrigerant circuit. The outdoor unit 11 constitutes the refrigerant circuit of the air conditioner 10 by being connected to the indoor unit 12 via a liquid-refrigerant connection pipe or a gas-refrigerant connection pipe. The outdoor unit 11 is provided with the outdoor unit control circuit 11X, and the outdoor unit control circuit 11X is connected to the indoor unit control circuits 12Xa to 12Xf via dedicated communication lines. In addition, the outdoor unit 11 is provided with an indoor unit connecting portion 11Y connected to the outdoor unit control circuit 11X and the control terminal 20, and the outdoor unit control circuit 11X and the control terminal 20 exchange information via the indoor unit connecting portion 11Y.

The outdoor unit 11 mainly includes the compressor 14, an outdoor heat exchanger 17, an outdoor fan, a switching mechanism, and the like. These components of the outdoor unit 11 are accommodated in an outdoor unit casing.

The compressor 14 sucks and compresses low-pressure gas refrigerant in a refrigeration cycle, and discharges high-pressure gas refrigerant in the refrigeration cycle. The compressor 14 has the compressor motor 14a for driving the compressor 14. The compressor 14 is, for example, an inverter-controlled compressor in which the compressor motor 14a is controlled by an inverter. However, the compressor 14 may also be a constant-speed compressor.

The outdoor heat exchanger 17 functions as an evaporator and/or a condenser of the refrigerant by exchanging heat between the refrigerant flowing inside the outdoor heat exchanger 17 and outdoor air.

The outdoor fan draws outdoor air into the outdoor unit casing, supplies the outdoor air to the outdoor heat exchanger 17, and then discharges the outdoor air to the outside of the outdoor unit casing. The outdoor fan is, for example, an inverter-controlled fan. However, the outdoor fan may also be a constant-speed fan.

The switching mechanism is a device capable of switching the flow of refrigerant in the refrigerant circuit, and is, for example, a four-way switching valve. Alternatively, the switching mechanism may be configured by combining a plurality of electromagnetic valves and pipes.

(2-2) Indoor Unit 12

The indoor unit 12 (12a to 12f) is a device that performs air conditioning of the air-conditioning target space 5 (5a to 5f). The indoor units 12a to 12f are separately installed in air-conditioning target spaces 5a to 5f, respectively. Each of the indoor units 12a to 12f is provided with a corresponding one of the indoor unit control circuits 12Xa to 12Xf. The indoor unit control circuits 12Xa to 12Xf are connected to the outdoor unit control circuit 11X via dedicated communication lines. The indoor unit 12 is operated by using the operation terminal 16 installed in a room. The operation terminal 16 includes, for example, a remote controller and/or an operation panel. Here, the plurality of indoor units 12a to 12f connected to the one outdoor unit 11 are individually associated with one or a plurality of operation terminals 16 and operated. Hereinafter, a case where the indoor unit 12 is an indoor unit of a type called a ceiling-embedded type will be described as an example. Note that the indoor unit 12 is not limited to a ceiling-embedded type indoor unit, and may be, for example, a wall-mounted type indoor unit or a floor-mounted type indoor unit.

The indoor unit 12 has a casing 41 that accommodates components of the indoor unit 12 therein. The casing 41 has an inlet for taking indoor air into the casing 41 and an outlet for blowing out the indoor air taken into the casing 41. As illustrated in FIG. 2, the heat exchanger 25, the indoor fan 13, and a filter 15 are mainly accommodated in each casing 41.

The heat exchanger 25 performs air conditioning of the air-conditioning target space 5 by functioning as an evaporator and/or a condenser of the refrigerant. The type of the heat exchanger 25 is not limited. For example, the heat exchanger 25 is a fin-and-tube heat exchanger having a plurality of heat transfer tubes and a plurality of heat transfer fins. The liquid side of the heat exchanger 25 is connected to the liquid-refrigerant connection pipe, and the gas side thereof is connected to the gas-refrigerant connection pipe. The heat exchanger 25 is bent so as to surround the indoor fan 13 in a plan view, and is disposed inside the casing 41. The heat exchanger 25 performs heat exchange between the indoor air drawn into the casing 41 by the indoor fan 13 and the refrigerant flowing inside the heat exchanger 25.

The indoor fan 13 is a fan that generates an airflow of air that is heat-exchanged in the heat exchanger 25. The indoor fan 13 draws indoor air into the casing 41 through the inlet of the casing 41, makes the drawn indoor air pass through the heat exchanger 25, and blows the indoor air that has passed through the heat exchanger 25 out of the casing 41 through the outlet. The indoor fan 13 is, for example, but not limited to, a centrifugal fan such as a turbo fan or a sirocco fan. The indoor fan 13 is rotationally driven by the fan motor 36. Here, the number of revolutions (frequency) of the fan motor 36 can be controlled by an inverter or the like, and thus, the air volume of the indoor fan 13 can be controlled.

The filter 15 has a function of removing dust contained in the indoor air. The filter 15 is disposed at the inlet of the casing 41 and upstream of the heat exchanger 25. When the indoor fan 13 is driven by the fan motor 36, the indoor air flows into the casing 41 through the inlet. When the indoor air passes through the inlet and is taken into the casing 41, the indoor air passes through the filter 15. When the indoor air passes through the filter 15, dust is removed from the indoor air by the filter 15. The indoor air from which dust has been removed by the filter 15 passes through the heat exchanger 25, and is blown out from the outlet to the outside of the casing 41. In this manner, the filter 15 removes dust from the indoor air and contributes to air conditioning.

As described above, various sensors are appropriately attached to predetermined positions of the indoor unit 12. For example, a human sensor that detects the number of people present in the air-conditioning target space 5, a dust sensor that detects dust contained in the indoor air, and the like are appropriately attached.

(3) Control Terminal 20

Hereinafter, functional blocks of the control terminal 20 constituting the device maintenance support system 1 will be described with reference to a drawing.

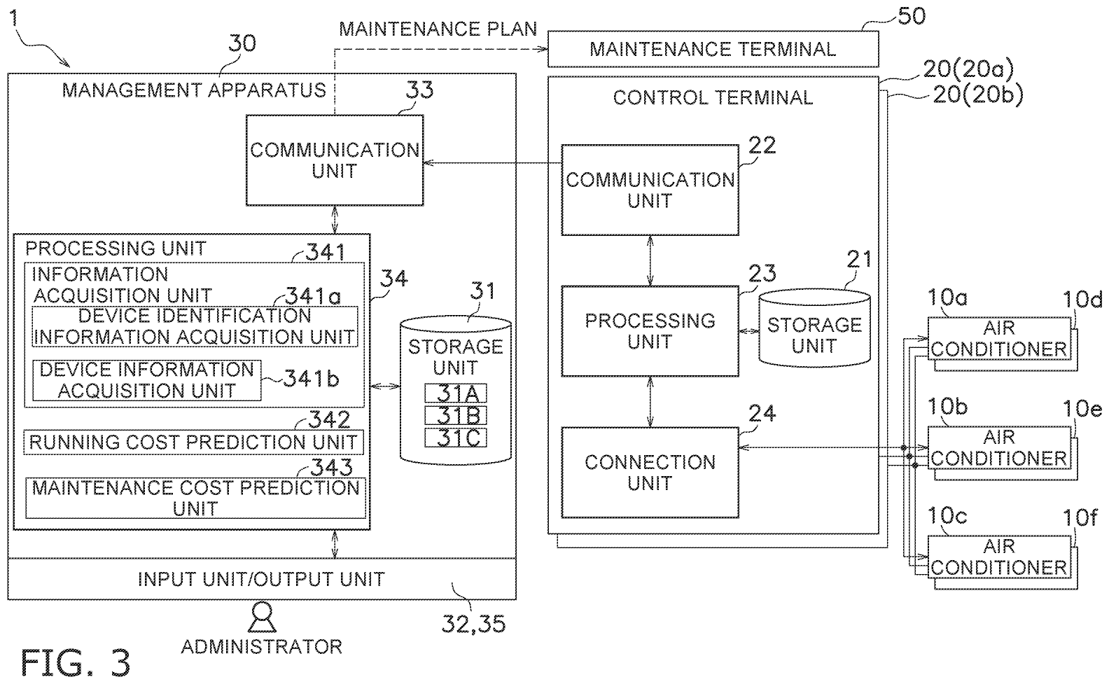

The control terminal 20 controls the operation of the air conditioner 10 by a connection unit 24 being connected to the outdoor unit control circuit 11X via the indoor unit connecting portion 11Y. As illustrated in FIG. 3, the control terminal 20 includes a storage unit 21, a communication unit 22, a processing unit 23, and the connection unit 24.

(3-1) Storage Unit 21

The storage unit 21 stores various types of information and includes a nonvolatile memory, a volatile memory, or the like. The storage unit 21 stores, for example, a program for executing various functions of the control terminal 20. The storage unit 21 stores, for example, the device identification information or the device information transmitted between the control terminal 20 and the management apparatus 30.

(3-1-1) Device Identification Information and Device Information

The device identification information is information for identifying a device, and is, for example, a device ID, a MAC address, a name, or the like, although not limited thereto.

The device information is information related to a maintenance target air conditioner (device) 10, and includes, for example, information such as parameters of the air conditioner 10, a model of the air conditioner 10, an operation environment of the air conditioner 10, a daily average operation time of the air conditioner 10, and a timing of the last maintenance of the air conditioner 10. Furthermore, the device information includes various types of data relating to the air conditioner 10 detected by various sensors attached to the air conditioner 10. The parameters will be described later.

The model of the air conditioner 10 refers to, for example, a product name or a model number indicating the manufacturer, the manufacturing date, and the performance such as capacity of the air conditioner 10.

The operation environment of the air conditioner 10 refers to, for example, a thermal environment of a region where the air conditioner 10 is installed, an electricity rate of the facility 2 where the air conditioner 10 is installed, the area of a room (air-conditioning target space) where the air conditioner 10 is installed, the number of users, a set temperature, and the like.

The daily average operation time of the air conditioner 10 is an average time during which the air conditioner 10 operates on a day.

The various types of data relating to the air conditioner 10 detected by the various sensors attached to the air conditioner 10 are, for example, data such as the amount of dust adhering to the filter 15.

Note that the device information stored in the storage unit 21 is not limited to these pieces of information, and can be appropriately changed. Furthermore, the information stored in the storage unit 21 can be appropriately updated from the management apparatus 30 or another terminal. For example, the device information stored in the storage unit 21 can be updated on the basis of a command from the management apparatus 30.

(3-1-1-1) Parameters

The parameters are information of numerical values that change depending on performance deterioration of components of the air conditioner 10.

In the present disclosure, the “components of the air conditioner 10” are at least any one of the filter 15 and the heat exchanger 25. However, the components of the air conditioner (device) 10 are not limited thereto, and are, for example, the fan motor 36, the outdoor heat exchanger 17, and the compressor motor 14a.

The “performance deterioration of components” refers to a state in which the heat exchange efficiency of the heat exchanger 25 decreases due to, for example, a large amount of dirt adhering to the heat exchanger 25. Alternatively, the state refers to a state in which a large amount of dust adheres to the filter 15, thereby reducing the drawing amount of the indoor air or reducing the ability to remove dust from the indoor air.

For example, the “numerical values that change depending on performance deterioration” are the number of revolutions of the compressor motor 14a, which changes as the heat exchange efficiency of the heat exchanger 25 decreases. As described above, the heat exchanger 25 is a component that functions as an evaporator or a condenser of the refrigerant, and when a large amount of dirt adheres to the heat exchanger 25, the heat exchange efficiency of the heat exchanger 25 decreases. In this case, the air conditioner 10 increases the number of revolutions of the compressor motor 14a to compensate for the decreased heat exchange efficiency. Alternatively, when a large amount of dust adheres to the filter 15, the heat exchange efficiency of the heat exchanger 25 may decrease due to a decrease in the drawing amount of the indoor air. In this case, the air conditioner 10 increases the number of revolutions of the compressor motor 14a of the compressor 14 to compensate for the decreased heat exchange efficiency. Alternatively, when a large amount of dust adheres to the filter 15, the air flow resistance of the filter 15 increases, and accordingly, the current value for the air conditioner 10 to rotate the fan motor 36 increases.

As described above, in a case of the performance deterioration of components of the air conditioner 10, there are numerical values that change depending on the performance deterioration, such as the number of revolutions of the compressor motor 14a and the current value for rotating the fan motor 36. In the present embodiment, such numerical values are appropriately collected as the parameters from the air conditioner 10. The parameters collected from the air conditioner 10 are stored in the storage unit 21 as the device information as described above.

The change in the parameters leads to an increase in running cost, which will be described later, and may increase a financial burden on a user of the air conditioner 10. For example, in a case where the number of revolutions of the compressor motor 14a tends to increase, it is conceivable that the amount of power consumption of the air conditioner 10 increases. Therefore, the financial burden on the user of the air conditioner 10 may increase.

(3-2) Communication Unit 22

The communication unit 22 performs communication with an external network including the communication network NW1. By the function of the communication unit 22, various commands and various types of data including the device identification information and the device information are exchanged between the control terminal 20 and the management apparatus 30.

(3-3) Processing Unit 23

The processing unit 23 executes various types of information processing. The processing unit 23 appropriately acquires the device identification information and the device information from the corresponding air conditioner 10 via the connection unit 24. The device identification information and the device information acquired by the processing unit 23 are stored in the storage unit 21 as described above. The processing unit 23 controls communication between the control terminal 20 and the management apparatus 30 via the communication unit 22. For example, in accordance with the communication condition, the processing unit 23 transmits, to the management apparatus 30, the device identification information and the device information acquired from the outdoor unit 11 to which the control terminal 20 is connected.

(3-4) Connection Unit 24

The connection unit 24 is connected to the indoor unit connecting portion 11Y of the outdoor unit 11. The control terminal 20 acquires information from the outdoor unit control circuit 11X via the connection unit 24 and the indoor unit connecting portion 11Y.

(4) Management Apparatus 30

Hereinafter, functional blocks of the management apparatus 30 included in the device maintenance support system 1 will be described with reference to drawings.

As illustrated in FIG. 1, the management apparatus 30 is connected to each of the control terminal 20 and a maintenance terminal 50 via the communication network NW1, and manages the operation state and the like of the air conditioner 10. The management apparatus 30 communicates with the control terminal 20 via the communication network NW1. The management apparatus 30 communicates with the maintenance terminal 50 via the communication network NW1. As illustrated in FIG. 3, the management apparatus 30 includes a storage unit 31, an input unit 32, a communication unit 33, a processing unit 34, and an output unit 35.

(4-1) Storage Unit 31

The storage unit 31 stores various types of information and includes a ROM, a RAM, and/or a hard disk. Here, the storage unit 31 includes an integrated management storage unit 31A, a device information storage unit 31B, and a running cost database 31C. The storage unit 31 also stores programs for executing various functions of the management apparatus 30.

The integrated management storage unit 31A stores information related to the air conditioner 10 managed by the management apparatus 30. For example, the integrated management storage unit 31A individually stores information on the facility 2 in which the air conditioner 10 is installed, information on the installation position of the outdoor unit 11, information on the installation positions of the indoor unit 12, information on the air-conditioning target space 5 in which the indoor unit 12 is installed, information on the maintenance worker of the air conditioner 10, correspondence relationships between the control terminals 20a and 20b and the air conditioners 10a to 10f, and the like.

The device information storage unit 31B individually stores the device information and the device identification information transmitted from each control terminal 20 in association with the air conditioners 10a to 10f.

(4-1-1) Running Cost Database 31C

The running cost database 31C is a database in which data relating to an increase in the running cost when a predetermined model of a predetermined device operates under a predetermined operating environment is accumulated. The predetermined device includes, for example, an air conditioner, a ventilator, a total heat exchanger, an air cleaner, and/or other refrigeration apparatuses. The predetermined model refers to, for example, a product name or a model number indicating a manufacturer of the predetermined device, a date of manufacture of the predetermined device, and performance such as capacity of the predetermined device. The predetermined operating environment includes various operating environments such as a thermal environment of a region where the predetermined device is installed, an electricity rate of the facility 2 where the predetermined device is installed, an air-conditioning load calculated from the area or a heat transmission rate of a room (air-conditioning target space) where the predetermined device is installed, the number of users of the room where the predetermined device is installed, a set temperature of the room where the predetermined device is installed, and a daily average operation time of the predetermined device. The running cost is a cost incurred by operating the predetermined device in a predetermined period.

Note that the configuration of the running cost database 31C described above is an example, and the running cost database 31C may appropriately include any information other than the listed information, and may not include all or a part of the listed information.

Note that the information stored in the storage unit 31 is not limited to these pieces of information and can be appropriately changed. The information stored in the storage unit 31 can be appropriately updated from the management apparatus 30 or another terminal. For example, the information stored in the running cost database 31C can be appropriately updated on the basis of the device information collected by the control terminal 20.

(4-2) Input Unit 32

The input unit 32 is an interface for inputting information to the management apparatus 30. The input unit 32 is implemented by a configuration such as a keyboard, a mouse, and/or a touch screen, and enables input of information to various reception screens. An administrator can input information on a user of the air conditioner 10 and information on the facility 2 to the management apparatus 30 via the input unit 32. The information on the user of the air conditioner 10 and the information on the facility 2 include, for example, information indicating that a third party is prohibited from entering the facility 2 for a predetermined period because the facility 2 is under construction. Thus, the management apparatus 30 can create a proposal for maintenance of the air conditioner 10 installed in the facility 2 in a period that does not correspond to the predetermined period. Various types of information input by the input unit 32 are stored in an appropriate storage area of the storage unit 31.

(4-3) Communication Unit 33

The communication unit 33 is an interface for communicating with the control terminal 20 and the maintenance terminal 50. For example, the communication unit 33 receives the device information from the control terminal 20. For example, the communication unit 33 transmits a maintenance plan to be described later to the maintenance terminal 50 according to the processing by the processing unit 34. The device information, the maintenance plan, and other various types of information transmitted and received by the communication unit 33 are stored in an appropriate storage area of the storage unit 31.

(4-4) Processing Unit 34

The processing unit 34 executes various types of information processing in the management apparatus 30, and includes a CPU, a cache memory, and the like. Here, the processing unit 34 includes an information acquisition unit 341, a running cost prediction unit 342, and a maintenance cost prediction unit 343.

(4-4-1) Information Acquisition Unit 341

The information acquisition unit 341 includes a device identification information acquisition unit 341a that acquires the device identification information and a device information acquisition unit 341b that acquires the device information. The device identification information is information for identifying a device, and is, for example, a device ID, a MAC address, or a name. When the device identification information acquisition unit 341a acquires the device identification information, the processing unit 34 can identify each device installed in the facility 2.

The device information is information related to the maintenance target device, and includes information such as the parameters. The parameters are as described in (3-1-1-1) above.

In this manner, by the information acquisition unit 341 acquiring the device identification information and the device information, the processing unit 34 can identify each air conditioner 10 installed in the facility 2, and can grasp the degree of the performance deterioration of the components constituting the air conditioner 10.

(4-4-2) Running Cost Prediction Unit 342

The running cost prediction unit 342 predicts the increase in the running cost due to the performance deterioration of components of the air conditioner 10. As described above, the running cost is a cost incurred by operating the air conditioner (device) 10 in the predetermined period, and is, for example, an electricity rate.

The running cost is considered to increase as the operation time of the air conditioner (device) 10 increases. Specifically, it is considered that as the operating time of the air conditioner (device) 10 increases, the change in the parameters increases, which results in the increase in the running cost. As will be described later, the running cost is a cost that is reduced by maintenance.

The running cost prediction unit 342 predicts the increase in the running cost of the air conditioner (device) 10 on the basis of the device information and the device identification information acquired by the information acquisition unit 341 and the information stored in the running cost database 31C.

For example, the running cost prediction unit 342 acquires given information of a given air conditioner 10 on the basis of the device information and the device identification information acquired by the information acquisition unit 341.

Subsequently, the running cost prediction unit 342 accesses the running cost database 31C and refers to data relating the transition of the increase in the running cost. At this time, the running cost prediction unit 342 refers to data relating to the transition of the running cost in a case where an air conditioner of the same model as the model of the given air conditioner 10 operates for the predetermined period under the same operating environment as the operating environment of the air conditioner 10, on the basis of the given information relating to the given air conditioner 10 acquired by the information acquisition unit 341. When the running cost database 31C does not include data about the air conditioner of the same model as the model of the air conditioner 10, the running cost prediction unit 342 preferably refers to data about an air conditioner of a model similar to the model of the air conditioner 10. Note that “an air conditioner of a model similar to the model of the air conditioner 10” is not limited, but is an air conditioner that is considered to have the same level of performance as the performance of the air conditioner 10 on the basis of, for example, the capacity or the like.

When the running cost database 31C does not include data related to the air conditioner that has operated under the same operating environment as the operating environment of the air conditioner 10, the running cost prediction unit 342 preferably refers to data on an air conditioner that has operated under an operating environment similar to the operating environment of the air conditioner 10. Note that “an air conditioner operated under an operating environment similar to the operating environment of the air conditioner 10” is not limited, but is an air conditioner that is considered to have operated under substantially the same environment as the environment of the air conditioner 10 on the basis of, for example, a thermal environment, an electricity rate, the area of a room, the number of users, a set temperature, a daily average operation time, or the like.

In this manner, by accessing the running cost database 31C, the running cost prediction unit 342 can refer to data such as how the running cost increases when an air conditioner of the same model as the model of the air conditioner 10 operates under the same operating environment as the operating environment of the air conditioner 10. Alternatively, for example, the running cost prediction unit 342 can predict how much the running cost will increase in a year if maintenance is not performed on the air conditioner 10. Alternatively, for example, the running cost prediction unit 342 can predict how the running cost will change in a year if maintenance is performed on the air conditioner 10 a predetermined number of times. On the basis of such data, the running cost prediction unit 342 can predict the increase in the running cost due to the performance deterioration of components of the air conditioner 10.

As described above, since the processing unit 34 of the management apparatus 30 includes the information acquisition unit 341 and the running cost prediction unit 342, the processing unit 34 can predict the running cost currently incurred in each air conditioner 10 installed in the facility 2 and the future increase in the running cost.

(4-4-3) Maintenance Cost Prediction Unit 343

The maintenance cost prediction unit 343 predicts a maintenance cost. The maintenance cost is a cost incurred each time maintenance is performed. When predicting the maintenance cost, the maintenance cost prediction unit 343 takes into account at least a number-of-devices dependent cost that changes depending on the number of maintenance target devices, and a constant cost incurred in accordance with maintenance. The number-of-devices dependent cost is a cost incurred when performing maintenance of a device, for example, a cost related to cleaning or replacement of the filter 15, and for example, a cost related to cleaning or replacement of the heat exchanger 25. The constant cost is, for example, a cost incurred when the maintenance worker makes a visit, and specifically is a cost such as a transportation fee.

The number-of-devices dependent cost is a cost that changes depending on the number of maintenance target devices. On the other hand, the constant cost is a cost that does not change as long as the number of maintenance target devices is less than or equal to a threshold. For example, when there are five devices whose filters needs to be cleaned and when there are ten devices whose filters needs to be cleaned, the number-of-devices dependent cost is higher in the latter case. On the other hand, even when there are five devices whose filters needs to be cleaned, or even when there are ten devices whose filters needs to be cleaned, the transportation fee or the like for the maintenance worker to make a visit is constant. Therefore, to perform maintenance, it is preferable to perform maintenance simultaneously on a plurality of devices on a single visit by taking into account the number-of-devices dependent cost and the constant cost in order to suppress the maintenance cost.

The constant cost may increase when the number of maintenance target devices exceeds the threshold. This is because, when there are a large number of maintenance target devices, it is necessary for a plurality of maintenance workers or more to make a visit, and it is assumed that the transportation fee or the like increases according to the number of maintenance workers. The setting of the threshold can be appropriately changed by the administrator inputting the threshold via the input unit 32.

As described above, since the processing unit 34 of the management apparatus 30 includes the information acquisition unit 341, the running cost prediction unit 342, and the maintenance cost prediction unit 343, the processing unit 34 can predict a total cost for each air conditioner 10 installed in the facility 2. The total cost is a sum of the increase in the running cost in the predetermined period and the maintenance cost. Although details will be described later, the total cost changes depending on the number of times of maintenance on the air conditioner 10.

(4-4-4) Output Unit 35

The output unit 35 outputs various types of information and includes various displays, speakers, or the like. The output unit 35 outputs, for example, the maintenance plan. Various types of information output by the output unit 35 can be output to the maintenance terminal 50 via the communication network NW1.

(5) Maintenance Terminal 50

The maintenance terminal 50 is a terminal operated by the maintenance worker who performs maintenance of a device. The maintenance terminal 50 receives the maintenance plan from the management apparatus 30 via a communication unit (not illustrated). Thus, the maintenance worker can perform maintenance such as abnormality diagnosis and response to malfunction of the air conditioner 10.

(6) Maintenance Support by Device Maintenance Support System 1

In general, it is considered that the performance of the components constituting air conditioners (devices) deteriorates as an operation time of the air conditioners increases. For this reason, air conditioners require maintenance according to the use state of the components of the air conditioners. Conventionally, a maintenance worker regularly visits a user for maintenance. Alternatively, the maintenance worker visits the user at a timing when a notification is received from an air conditioner. However, in general, an installation environment and an operation environment of air conditioners differ for each air conditioner, and accordingly, an optimal maintenance timing of the air conditioners differs for each air conditioner. For example, for an air conditioner installed in an air-conditioning target space with a large number of users and an air conditioner installed in an air-conditioning target space with a small number of users, even if the model and performance of both the air conditioners are the same, the time taken for the components constituting the former to deteriorate differs from the time taken for the components constituting the latter to deteriorate. For this reason, the timing when the maintenance worker makes a regular visit is not necessarily a financially optimal maintenance timing. On the other hand, if the maintenance worker makes a visit in response to every notification from an air conditioner, the maintenance cost will increase, and an excessive financial burden may be imposed on the user. Alternatively, a method of collectively performing maintenance after notifications from all the air conditioners installed in the air-conditioning target spaces may be considered. However, in this case, although an increase in the maintenance cost of the air conditioners is suppressed, the running cost of the air conditioners may increase, and a financial burden may be imposed on the user. In this manner, the running cost of the air conditioners increases if the maintenance is not performed. However, if the timing for maintenance is not considered, the maintenance cost rather exceeds the running cost and causes the financial burden on the user. However, conventionally, detailed studies have not been made on the optimal maintenance timing.

The present disclosure has been made in view of the above points, and an object thereof is to provide the device maintenance support system 1 that proposes, to a user, a maintenance target device for which maintenance is recommended and the maintenance timing from a financial point of view.

Although the predetermined period is not limited, it is assumed here that the predetermined period is one year.

Hereinafter, the device maintenance support by the device maintenance support system 1 will be described in detail.

The device maintenance support system 1 is a system that proposes, among combinations of the devices on which maintenance is to be performed/not to be performed and the maintenance timing in a case of performing maintenance, the maintenance target device and the maintenance timing thereof for which a total cost is the lowest, the total cost being a sum of the increase in the running cost of all the devices and the maintenance cost incurred for the maintenance target device.

As described above, the running cost is a cost incurred by operating the air conditioner (device) 10 in the predetermined period, and can be predicted by the running cost prediction unit 342. The running cost is, for example, an electricity rate. The running cost is considered to increase as the operation time of the air conditioner 10 increases, but decreases by performing maintenance. Therefore, in order to suppress the increase in the running cost, it is effective to perform regular maintenance. On the other hand, the maintenance cost is incurred by performing maintenance. Therefore, it is considered that suppressing the increase in the running cost while minimizing the number of times of performing maintenance reduces the financial burden on the user.

As described above, the maintenance cost is a cost incurred each time maintenance is performed, and can be predicted by the maintenance cost prediction unit 343. The maintenance cost includes, for example, a cleaning and replacement cost of the filter 15, a cleaning and replacement cost of the heat exchanger 25, and a visit expense of the maintenance worker. By performing maintenance simultaneously on a plurality of devices on a single visit, it is possible to reduce the visit expense of the maintenance worker. For this reason, in a case of performing maintenance, it is preferable that a plurality of devices be simultaneously subjected to maintenance. The maintenance cost is not incurred if maintenance is not performed.

As described above, the total cost is the sum of the running cost in the predetermined period and the maintenance cost. As long as maintenance is not performed on the air conditioner (device) 10, the total cost is the increase in the running cost since the maintenance cost is not incurred.

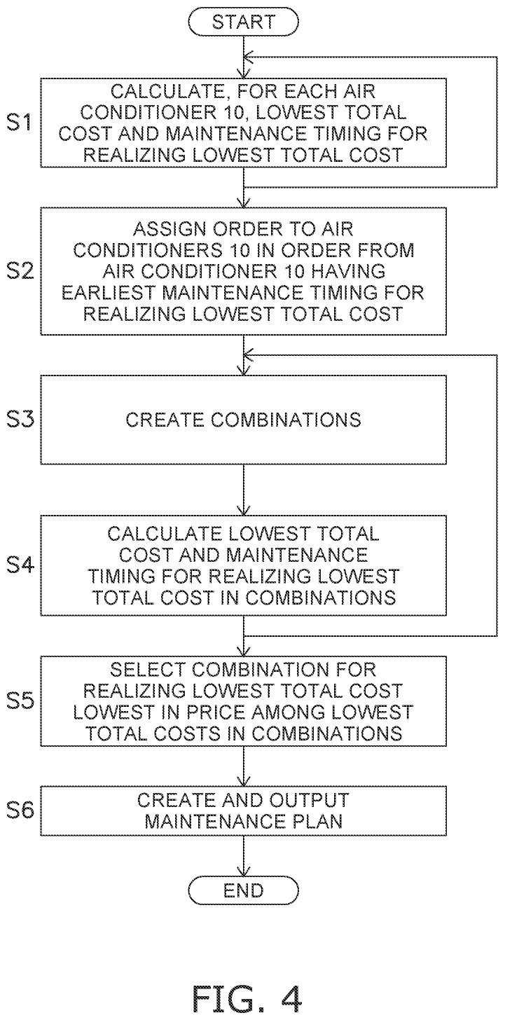

Hereinafter, a series of procedures in which the device maintenance support system 1 proposes the maintenance target device and the maintenance timing will be described with reference to FIG. 4.

The flow of the process illustrated in FIG. 4 is merely an example, and can be appropriately changed. For example, another step that is not illustrated may be included before or after each step, or the order of steps may be changed.

(6-1)

In step S1, the processing unit 34 of the device maintenance support system 1 calculates, for each air conditioner (device) 10 installed in the facility 2, the lowest total cost in a case of performing/not performing maintenance and the maintenance timing for realizing the lowest total cost. In other words, the processing unit 34 calculates, for one air conditioner 10, whether maintenance is to be performed, whether maintenance is not to be performed, or when maintenance is to be performed in a case of performing maintenance, in order to realize the lowest total cost.

In order to calculate the lowest total cost and the maintenance timing for realizing the lowest total cost for each air conditioner 10, the processing unit 34 calculates the following Equation 1.

E(T/n+1)×(n+1)+F×n=C Equation 1:

In Equation 1, T is the predetermined period, E is the increase in the running cost in the predetermined period, n is the number of times of maintenance, F is the maintenance cost, and C is the total cost. In the calculation here, the predetermined period is one year. Changing arbitrarily the number substituted for n in Equation 1 changes the value of E, which is the running cost, and the value of C, which is the total cost. Therefore, the number of times of maintenance for realizing the lowest total cost can be obtained by arbitrarily changing the number substituted for n. The amount of the increase in the running cost that changes depending on a change in the value of n can be appropriately predicted by the running cost prediction unit 342 as described above. Furthermore, the maintenance cost can be predicted by the maintenance cost prediction unit 343, and the total cost in a case of not performing maintenance can be obtained by substituting 0 for n.

In this manner, for each of the air conditioners 10a to 10f, the processing unit 34 grasps the lowest total cost in the predetermined period and the number of times of maintenance for realizing the lowest total cost.

By grasping the number of times of maintenance for realizing the lowest total cost of each air conditioner 10, the processing unit 34 can grasp the maintenance timing (optimal maintenance timing) for realizing the lowest total cost of the air conditioner 10. For example, in a case where the lowest total cost of one air conditioner 10 is realized when the number of times of maintenance in the predetermined period (here, one year) is four for the air conditioner 10, the maintenance timing of the air conditioner 10 is once every three months.

The processing in step S1 described above is repeated until the lowest total cost in a case of performing/not performing maintenance and the maintenance timing for realizing the lowest total cost are calculated for each of all the air conditioners 10 installed in the facility 2.

(6-2)

Subsequently, in step S2, the processing unit 34 assigns an order to the air conditioners 10 in order from the air conditioner 10 having the earliest optimal maintenance timing.

Specifically, the processing unit 34 assigns an order to the air conditioners 10a to 10f as a device A, a device B, a device C, . . . and a device F in order from the air conditioner having the earliest optimal maintenance timing.

In the following, it is assumed that the optimal maintenance timing is earlier in the order of the air conditioners 10a, 10b, 10c, 10d, 10e, and 10f in the predetermined period. In this case, the device A is the air conditioner 10a, the device B is the air conditioner 10b, the device C is the air conditioner 10c, the device D is the air conditioner 10d, the device E is the air conditioner 10c, and the device F is the air conditioner 10f. Note that the order of the device A to the device F is not limited to this, and can be appropriately changed according to the earliness of the optimal maintenance timing of the air conditioner 10.

(6-3)

In step S2, the processing unit 34 assigns the order as the device A, the device B, the device C, . . . and the device F in order from the air conditioner 10 having the earliest (closest) optimal maintenance timing.

Subsequently, in step S3, the processing unit 34 creates combinations of devices among the device A, the device B, the device C, . . . and the device F. A combination of devices is, for example, a combination of the device A and the device B. Alternatively, a combination of devices is, for example, a combination of the device A, the device B. and the device C. Alternatively, a combination of devices is, for example, a combination of the device A, the device B, the device C, and the device D and the like.

In step S3, the processing unit 34 does not combine devices having distant optimal maintenance timings as a method of combining a plurality of devices.

For example, the processing unit 34 is suppressed from creating combinations such as a combination of the device A and the device C, a combination of the device A and the device D, and a combination of the device A, the device B, and the device D. This is because, in a case of performing maintenance simultaneously by combining devices having distant optimal maintenance timings, the increase in the running cost of any of the devices is incurred, and thus, this is not considered to contribute to suppression of an increase in the financial cost of the user. In addition, by excluding calculation for such a case, the load related to the calculation performed in the processing unit 34 is reduced.

(6-4)

In step S3, the processing unit 34 creates the combinations of devices.

In step S4, the processing unit 34 calculates the lowest total cost and the maintenance timing for realizing the lowest total cost in a case of performing maintenance simultaneously on the plurality of devices constituting the combinations created in step S3.

For example, in a case where a combination created in step S3 is a combination of the device A and the device B, the processing unit 34 calculates the lowest total cost and the maintenance timing for realizing the lowest total cost in a case of performing maintenance simultaneously on the device A (the air conditioner 10a) and the device B (the air conditioner 10b). Alternatively, in a case where a combination created in step S3 is a combination of the device A, the device B, and the device C, the lowest total cost and the maintenance timing for realizing the lowest total cost in a case of performing maintenance simultaneously on the device A (the air conditioner 10a), the device B (the air conditioner 10b), and the device C (the air conditioner 10c) are calculated.

The lowest total cost and the maintenance timing for realizing the lowest total cost in a case of performing maintenance simultaneously on the plurality of devices (the air conditioners 10) constituting the combinations created in step S3 can be calculated from a total maintenance cost of the respective devices (the air conditioners 10) constituting the combinations and a total increase in the running cost.

The processing unit 34 calculates the following Equation 2 in order to calculate the lowest total cost and the maintenance timing for realizing the lowest total cost in a case of performing maintenance simultaneously on the plurality of devices (the air conditioners 10) constituting the combinations created in step S3.

ΣE(T/n+1)×(n+1)+ΣF×n=C Equation 2:

In Equation 2, T is the predetermined period, ΣE is the total increase in the running cost of the respective devices in the predetermined period, n is the number of times of maintenance. ΣF is the total maintenance cost of the respective devices, and C is the total cost. In the calculation, the predetermined period is one year as described above. Changing arbitrarily the number substituted for n in Equation 2 changes the value of ΣE, which is the total increase in the running cost of the respective devices, and the value of C, which is the total cost. Therefore, the number of times of maintenance for realizing the lowest total cost in a case of performing maintenance simultaneously by combining a plurality of devices among the plurality of devices can be obtained by arbitrarily changing the number substituted for n. As described above, the total increase in the running cost that changes depending on the change in the value of n can be appropriately predicted by the running cost prediction unit 342. Furthermore, the total cost in a case of not performing maintenance by combining a plurality of devices among the plurality of devices can be obtained by substituting 0 for n.

In addition, with respect to ΣF, which is the total maintenance cost of the respective devices, the processing unit 34 takes into account the number-of-devices dependent cost and the constant cost. Specifically, by taking into account performing maintenance simultaneously on a plurality of devices, the visit expense or the like of the maintenance worker is taken into account so as not to be doubly accounted as ΣF.

In this manner, the processing unit 34 grasps the lowest total cost in a case of performing maintenance simultaneously on the plurality of devices constituting the combinations created in step S3, and the number of times of maintenance for realizing the lowest total cost.

Furthermore, by grasping the number of times of maintenance for realizing the lowest total cost in a case of performing maintenance simultaneously on the plurality of devices constituting the combinations created in step S3, the processing unit 34 can grasp the maintenance timing for realizing the lowest total cost in a case of performing maintenance simultaneously on the plurality of devices constituting the combinations created in step S3.

For example, in a case of performing maintenance simultaneously on the device A and the device B by combining the device A (the air conditioner 10a) and the device B (the air conditioner 10b), if the total cost is the lowest when the number of times of maintenance is six (n=6) in the predetermined period (here, one year), the maintenance timing of the devices A+B is once every two months.

In this manner, the processing unit 34 calculates the lowest total cost and the maintenance timing for realizing the lowest total cost in a case of performing maintenance simultaneously on the plurality of devices constituting the combinations created in step S3.

Each time a combination related to the plurality of devices (the air conditioners 10) is created in step S3, the processing unit 34 may calculate, in step S4, the lowest total cost and the maintenance timing for realizing the lowest total cost in a case of performing maintenance simultaneously on the plurality of devices constituting the combination. Alternatively, after creating a plurality of combinations in step S3, the processing unit 34 may proceed to step S4 and calculate, for each of the plurality of combinations, the lowest total cost and the maintenance timing for realizing the lowest total cost in a case of performing maintenance simultaneously on the plurality of devices constituting the combinations.

The processing of step S3 and step S4 described above is repeated until the lowest total cost and the maintenance timing for realizing the lowest total cost are calculated for all combinations assumed from the plurality of devices.

(6-5)

By repeating the processing of step S3 and step S4, the lowest total cost and the maintenance timing for realizing the lowest total cost ar calculated for each of the combinations created in step S3.

In step S5, the processing unit 34 selects a combination for which the lowest total cost is the lowest in price among these combinations.

For example, for each of cases of performing maintenance simultaneously by combining the device A and the device B, performing maintenance by combining the device A, the device B, and the device C, or performing maintenance by combining the device A, the device B, the device C, and the device D . . . , the lowest total cost (and the maintenance timing for realizing the lowest total cost) is present. In step S5, the processing unit 34 selects a combination that realizes the lowest total cost that is the lowest in price among these lowest total costs.

The air conditioners 10 constituting the combination and the maintenance timing for realizing the lowest total cost in the combination are proposed.

For example, in a case where a combination of the device A and the device B on which maintenance is to be performed simultaneously one month later is a combination in which the total cost in the predetermined period (here, one year) is the lowest among all combinations, the air conditioner 10a and the air conditioner 10b are proposed as the maintenance target devices, and the maintenance timing thereof is one month later.

At this time, if the processing unit 34 determines that there is a malfunctioning air conditioner 10 on the basis of the device information acquired by the information acquisition unit 341, the processing unit 34 proposes the malfunctioning air conditioner 10 as the maintenance target device. In other words, upon detection of the malfunctioning air conditioner (device) 10, on the premise of performing maintenance of the malfunctioning device, the maintenance timing for which the total cost is the lowest in the predetermined period and a combination therefor are calculated. As described above, in a case of performing maintenance by the maintenance worker making a visit, it is preferable to perform maintenance simultaneously on a plurality of devices on a single visit by taking into account the number-of-devices dependent cost and the constant cost in order to suppress the maintenance cost. In this manner, upon detection of the malfunctioning air conditioner 10, it is proposed to perform maintenance on the air conditioner 10 simultaneously with the next or subsequent maintenance. Thus, the maintenance cost is suppressed.

In addition, the processing unit 34 can calculate a combination for which the total cost is the lowest in the predetermined period while taking into account information input to the management apparatus 30 via the input unit 32. Thus, it is possible to propose the maintenance target device and the maintenance timing by taking into account various circumstances of the user and the facility 2.

(6-6)

Subsequently, in step S6, the processing unit 34 outputs a maintenance plan via the output unit 35. The maintenance plan includes any of the maintenance target device to be recommended, the maintenance timing, the total cost, device installation location information, a maintenance content, and a time required for maintenance. The maintenance plan is output by the output unit 35 to, for example, various displays, speakers, or the like.

The maintenance plan output via the output unit 35 is output to the maintenance terminal 50 via the communication unit 33. Although not illustrated, the maintenance plan may be output to a display and a speaker of the user of the air conditioner (device) 10.

In this manner, the device maintenance support system proposes the maintenance target device and the maintenance timing thereof for which the total cost is the lowest in the predetermined period.

(7) Characteristics

(7-1)

The device maintenance support system 1 according to the present disclosure is a system that proposes, among the plurality of devices installed, the maintenance target device and the maintenance timing. The device maintenance support system 1 includes the information acquisition unit 341 and the running cost prediction unit 342. The information acquisition unit 341 acquires, from the devices, the device identification information and the device information. The device information includes parameters that change according to performance deterioration of components of the devices. The running cost prediction unit 342 predicts the increase in the running cost due to the performance deterioration of components of the devices. The device maintenance support system 1 proposes, among combinations of the devices on which maintenance is to be performed/not to be performed and the maintenance timing in a case of performing maintenance, the maintenance target device and the maintenance timing thereof for which the total cost is the lowest, the total cost being a sum of the increase in the running cost of all the devices and the maintenance cost incurred for the maintenance target device.

The device maintenance support system 1 proposes, among combinations of the devices on which maintenance is to be performed/not to be performed and the maintenance timing in a case of performing maintenance, the maintenance target device and the maintenance timing thereof for which the total cost is the lowest. Thus, a financial burden on a user is suppressed.

In addition, as compared with a case where the maintenance worker makes a visit in response to every notification from the air conditioner, a temporal burden on the user is suppressed.

(7-2)

The device maintenance support system 1 is characterized in that, for the maintenance cost, at least the number-of-devices dependent cost incurred in accordance with the number of maintenance target devices and the constant cost incurred in accordance with maintenance are taken into account.

The device maintenance support system 1 takes into account at least the number-of-devices dependent cost, which is a cost incurred in accordance with the number of maintenance target devices, and the constant cost, which is a cost incurred in accordance with maintenance. Thus, the financial burden on the user is further suppressed.

In other words, the device maintenance support system 1 takes into account the number-of-devices dependent cost and the constant cost when calculating the total cost. The number-of-devices dependent cost is a cost that increases or decreases as the number of maintenance target devices increases or decreases, and the constant cost is a cost that does not increase or decrease when the number of maintenance target devices is equal to or less than a threshold. In this manner, the financial burden on the user is further suppressed.

(7-3)

The device maintenance support system 1 is characterized in that, in selection of the combinations, calculation is performed in order from a device having the earliest maintenance timing when calculating the maintenance timing with the lowest cost in a case of performing maintenance on each of the devices individually.

The device maintenance support system 1 performs calculation in order from the earliest maintenance timing when calculating the maintenance timing with the lowest cost in a case of performing maintenance on each of the devices individually. Thus, it is possible to exclude a combination of devices that may increase the running cost or the maintenance cost when calculating the total cost. Thus, the financial burden on the user is further suppressed.

Furthermore, by excluding the combination of devices that may increase the running cost or the maintenance cost, the amount of processing performed when the processing unit 34 calculates the total cost is reduced. Therefore, the load on the device maintenance support system 1 is reduced.

(7-4)

The device maintenance support system 1 is characterized in that, upon detection of a malfunction of a device from the device information, the detected device is set as the maintenance target device.

Upon detection of the malfunctioning device, the device maintenance support system 1 sets the malfunctioning device as the maintenance target device. In other words, upon detection of the malfunctioning device, on the premise of performing maintenance of the malfunctioning device at the next or subsequent maintenance, the maintenance target device and the maintenance timing thereof for which the total cost is the lowest are proposed. In a case where a plurality of devices such as the air conditioners 10 are installed in the facility 2, even if one of the plurality of air conditioners 10 malfunctions, it is not always necessary to immediately perform maintenance. In addition, as described above, in a case of performing maintenance by the maintenance worker making a visit, it is preferable to perform maintenance simultaneously on a plurality of devices on a single visit by taking into account the number-of-devices dependent cost and the constant cost in order to suppress the maintenance cost. In the device maintenance support system 1, by including the malfunctioning device in the maintenance target device, it is possible to perform maintenance of the malfunctioning device at a timing when the financial burden on a user is not increased.

(8) Modifications

The above embodiment can be modified as appropriate as illustrated in the following modifications. Note that each of the modifications may be combined with another modification as long as no contradiction occurs.

(8-1) Modification A

In the above embodiment, the facility 2 is described as an office building, a commercial building, or a condominium, for example. However, the facility 2 is not limited to the building described above, and may be a house or the like, for example. In other words, the device maintenance support system 1 according to the present disclosure is also applicable to a device installed in a house or the like.

(8-2) Modification B

In the embodiment described above, the device maintenance support system 1 proposes the maintenance target device and the maintenance timing thereof on the basis of the increase in the running cost of the devices predicted by the running cost prediction unit 342. However, the configuration of the device maintenance support system 1 is not limited to this. For example, the device maintenance support system 1 may be a system that determines a threshold of an operation time for each of the devices installed in the facility 2, and may predict a timing when each device will exceed the threshold of the operation time determined for the device on the basis of the operation time of each of the devices acquired by the information acquisition unit 341 of the device maintenance support system 1. The device maintenance support system 1 may propose the maintenance target device and the maintenance timing thereof on the basis of the prediction of the timing when each device will exceed the threshold of the operation time of the device. In this case, in order to suppress the total cost, the device maintenance support system 1 may be a system that proposes simultaneous maintenance of a plurality of devices that will exceed the threshold of the operation time at close timings.

(8-3) Modification C

In the above embodiment, an example in which each one of the indoor units 12 is disposed in a corresponding one of the air-conditioning target spaces 5 has been described. However, the arrangement method of the indoor units 12 is not limited to this. For example, a plurality of indoor units 12 may be arranged in one air-conditioning target space 5.

(8-4) Modification D

In step S3, the processing unit 34 may create a combination of the device B and the device C, a combination of the device D and the device E, a combination of the device B, the device C, and the device D, and the like. In addition, in step S4, the processing unit 34 may calculate the lowest total cost related to these combinations and the maintenance timing for realizing the lowest total cost.

In this case, in step S5, a combination realizing the lowest total cost in price may be selected from among a variety of combinations such as a combination of the device A on which maintenance is to be performed independently, the device B and the device C on which maintenance is to be performed simultaneously, the device D and the device E on which maintenance is to be performed simultaneously, and the device F on which maintenance is to be performed independently, and a combination of the device A on which maintenance is to be performed independently, the device B, the device C. and the device D on which maintenance is to be performed simultaneously, and the device E on which maintenance is to be performed independently, and the device F on which maintenance is not to be performed in the predetermined period.

Although the embodiment of the present disclosure has been described above, it should be understood that various changes can be made on the forms and details without departing from the spirit and scope of the present disclosure described in the claims.

1. A device maintenance support system that proposes, among a plurality of devices installed, a maintenance target device and a maintenance timing, the device maintenance support system comprising:
an information acquisition unit configured to acquire, from the devices, device identification information and device information including parameters that change according to performance deterioration of components of the devices; and
a running cost prediction unit configured to predict an increase in a running cost due to the performance deterioration of components of the devices,
among combinations of the devices on which maintenance may be performed and the maintenance timing in a case of performing maintenance,
the maintenance target device and the maintenance timing thereof for which a total cost is lowest are proposed, the total cost being a sum of the increase in the running cost of all the devices and the maintenance cost incurred for the maintenance target device.

2. The device maintenance support system according to claim 1, wherein
for the maintenance cost, at least
a number of devices dependent cost incurred in accordance with a number of maintenance target devices and
a constant cost incurred in accordance with maintenance are taken into account.

3. The device maintenance support system according to claim 2, wherein
in selection of the combinations, calculation is performed in order from a device having an earliest maintenance timing when calculating the maintenance timing with the lowest cost in a case of performing maintenance on each of the devices individually.

4. The device maintenance support system according to claim 2, wherein
upon detection of a malfunction of a device from the device information, the detected device is set as the maintenance target device.

5. The device maintenance support system according to claim 2, wherein
a maintenance plan including any one of
the maintenance target device to be recommended,
the maintenance timing,
the total cost,
device installation location information,
a maintenance content, and
a time required for maintenance is output.

6. The device maintenance support system according to claim 2, wherein
the devices are at least any one of
an air conditioner,
a ventilator,
a total heat exchanger, and
an air cleaner.

7. The device maintenance support system according to claim 2, wherein
the components are at least any one of
a filter and
a heat exchanger.

8. The device maintenance support system according to claim 1, wherein
in selection of the combinations, calculation is performed in order from a device having an earliest maintenance timing when calculating the maintenance timing with the lowest cost in a case of performing maintenance on each of the devices individually.

9. The device maintenance support system according to claim 8, wherein
upon detection of a malfunction of a device from the device information, the detected device is set as the maintenance target device.

10. The device maintenance support system according to claim 8, wherein
a maintenance plan including any one of
the maintenance target device to be recommended,
the maintenance timing,
the total cost,
device installation location information,
a maintenance content, and
a time required for maintenance is output.

11. The device maintenance support system according to claim 8, wherein
the devices are at least any one of
an air conditioner,
a ventilator,
a total heat exchanger, and
an air cleaner.

12. The device maintenance support system according to claim 8, wherein
the components are at least any one of
a filter and
a heat exchanger.

13. The device maintenance support system according to claim 1, wherein
upon detection of a malfunction of a device from the device information, the detected device is set as the maintenance target device.

14. The device maintenance support system according to claim 13, wherein
a maintenance plan including any one of
the maintenance target device to be recommended,
the maintenance timing,
the total cost,
device installation location information,
a maintenance content, and
a time required for maintenance is output.

15. The device maintenance support system according to claim 13, wherein
the devices are at least any one of
an air conditioner,
a ventilator,
a total heat exchanger, and
an air cleaner.

16. The device maintenance support system according to claim 13, wherein
the components are at least any one of
a filter and
a heat exchanger.

17. The device maintenance support system according to claim 1, wherein
a maintenance plan including any one of
the maintenance target device to be recommended,
the maintenance timing,
the total cost,
device installation location information,
a maintenance content, and
a time required for maintenance is output.

18. The device maintenance support system according to claim 1, wherein
the devices are at least any one of
an air conditioner,
a ventilator,
a total heat exchanger, and
an air cleaner.

19. The device maintenance support system according to claim 1, wherein
the components are at least any one of
a filter and
a heat exchanger.
